(19) United States
(12) Patent Application Publication
(10) Pub. No.: US 2015/0203234 A1
(43) Pub. Date: Jul. 23, 2015

(54) LABEL DISPENSER

(71) Applicant: I-LABEL BVBA, Lemberge (BE)

(72) Inventor: Ruben Albert Marcel Deleu, Lemberge (BE)

(73) Assignee: I-LABEL BVBA, Lemberge (BE)

(21) Appl. No.: 14/419,773

(22) PCT Filed: May 24, 2013
(86) PCT No.: PCT/EP2013/060726

§ 371 Date: Feb. 5, 2015

(30) Foreign Application Priority Data
May 25, 2012 (GB) 1209188.0
Feb. 26, 2013 (GB) 1303364.2

(51) Int. Cl. B65C 9/00

(52) U.S. Cl. CPC B65C 9/0006; B65C 2009/0009

(57) ABSTRACT

The invention relates to the peel-off plate enabling automatic peeling and labelling of ultra thin or extremely flexible labels, such as for example used in labelling of small sample vials. The peel-off plate of the present invention is characterized in that in enables a stepwise release from the labels (3) of the backing sheet (10), based on a support surface having at least two peeling edges (1a, 1b) and corresponding discharge zones, that do not lie in line with one another, with respect to the running direction of the machine. It is further characterized in that label support means (6) are present posterior to all of the peeling edges, providing support from underneath to the label while being removed from the backing sheet up to the deposit edge where the user can grasp it or it is being dispensed on the item being labelled.

### FIELD OF THE INVENTION

This invention relates to methods and apparatus for peeling adhesive labels from a release coated web supply, while holding the peeled label and applying the label onto an item. The invention in particular relates to the peel-off plate enabling automatic peeling and labelling of ultra thin or extremely flexible labels, such as for example used in labelling of small sample vials.

### BACKGROUND TO THE INVENTION

Adhesive labels are generally supplied on a large tape roll of release coated web (also known as backing sheet). Automatic peel and apply apparatus of the prior art generally holds the roll of labels and pulls the web (backing sheet), label side up, over a plate (peel-off plate) with a sharp edge and then pulls the web beneath the plate so that the label extends tangentially from the edge free of the web as the web changes direction. A problem in the operation of such automatic dispensing machines is to assure that the labels peeled from the backing sheet are presented in an orientation in which they are easily grasped by the user and/or to ensure precision in the final placement onto the item being labelled. It is further desired that the labels are prevented from being entrapped in rotating or moving portions of the machine. Accordingly prior art label dispensing devices have various complex mechanisms to provide a guidance to the label when released from the web. Unfortunately, none of the available solutions prevent the typical problems associated with ultra thin or extremely flexible labels. Such labels tend to move along with the backing sheet while being pulled over the peeling edge of the peel-off plate so the label hasn't been released from the backing sheet, and even when being released from the backing sheet they are prone to ruffling, bending or wrinkling, which prevents them from being used in the present automatic dispensing machines.

It is an object of the present invention to provide a peel-off plate for use with existing (not only) label dispensing machines and enabling an automated dispensing of ultra thin and extremely flexible labels onto an item.

### SUMMARY OF THE INVENTION

In a first aspect the present invention provides a peel-off plate for use with a backing sheet carrying adhesive labels to be dispensed in a label-dispensing machine, comprising a surface with at least two peeling edges (1) positioned relatively to corresponding discharge zones (2); characterized in that said peeling edges do not lie in line with one another, with respect to the running direction of the machine; and in that it comprises label support means posterior to all discharge zones up to the shed zone (5) were the label can be grasped by the user or is being dispensed on the item being labelled.

As such, the labels are stepwise released from the backing sheet, and supported from underneath up to the discharge edge of the peel-off plate, i.e. shed zone (5), preventing premature label dislodgments and loss of ultra thin or extremely flexible labels, which has been a problem with existing label dispensing machines, and assuring the peeling of ultra thin or extremely flexible labels.

In a particular embodiment of the present invention, and with reference to FIGS. 1 and 2, said peeling edges consist of a first peeling edge (1a) positioned centrally with respect to the labels to be dispensed, two further peeling edges (1b) flanking said first peeling edge, and characterized in that said first peeling edge and further flanking peeling edges do not lie in line with one another, with respect to the running direction of the machine.

In an even more particular embodiment the first peeling edge (1a), positioned centrally with respect to the labels to be dispensed, is proximal to the leading edge of the peel-off plate. In other words within this embodiment a central portion of the backing sheet (10a) is first removed from the roll of labels, followed by the removal of the flanking regions (10b) of the back sheet.

In an alternative embodiment, and with reference to FIGS. 3 and 4, the order of said peeling edges may be reversed in that the first peeling edges (1a) are at the perimeters and flanking the central portion of the backing sheet to be removed, and a central further peeling edge (1b) is positioned centrally with respect to the labels to be dispensed, and characterized in that said first peeling edges and further peeling edges do not lie in line with one another, with respect to the running direction of the machine.

In analogy with the foregoing embodiment, also in this embodiment the first peeling edges (1a), are proximal to the leading edge of the peel-off plate. In other words within this embodiment flanking portions of the backing sheet (10b) are first removed from the roll of labels, followed by the removal of the central region (10a) of the back sheet. In other words, within this embodiment the central portion of the backing sheet is removed after the flanking portions at peeling edges (1b).

From these embodiments it is evident that, there is no limitation as to the orientation of the peeling edges vis-à-vis the running direction of the machine. Said peeling edges may each independently be at an angle or perpendicular to the central axis of the tape roll carrying the labels to be dispensed. An exemplary embodiment wherein the peeling edges are perpendicular vis-à-vis the running direction of the machine is provided in the drawings hereinafter. In a possible alternative embodiment the first peeling edge could be perpendicular with respect to the running direction of the machine and the flanking peeling edge at an angle, e.g. an opening angle with respect to the running direction of the machine.

As will become apparent from the functional description accompanying the drawings herein below, during the peeling (removal) of the backing sheet the peel-off plate provides support underneath the label (3) in its travel from the leading edge (4) of said peel-off plate to the shed zone hereinafter also referred to as the deposit edge (5) where it can be grasped by the user or is being dispensed on the item being labelled.

Consequently, in a particular embodiment said support means (6a) are adjacent to the first peeling edge(s) positioned centrally (FIGS. 1 and 2) or at the perimeter (FIGS. 3 and 4) with respect to the labels to be dispensed; in an another embodiment (FIGS. 1 and 2) said support means are adjacent (6c) to the two peeling edges flanking the first peeling edge; more in particular adjacent to the first peeling edge positioned centrally with respect to the labels to be dispensed, and adjacent to the peeling edges (6b) flanking said first peeling edge; thus in an even more particular embodiment of the present invention support means are present adjacent and posterior to each of the peeling edges present within the peel-off plate. Within the context of the present invention at least one of said support means (6a or 6b) provides support underneath the label (3) in its travel from the leading edge (4) of said peel-off plate to the shed zone hereinafter also referred to as the deposit edge (5). In a particular embodiment support means (6a) adjacent to the first peeling edge(s) provides support underneath the label (3) in its travel from the leading edge (4) of said peel-off plate to the shed zone hereinafter also referred to as the deposit edge (5).

In principle any material that provides on the one hand support to the label being peeled, and on the other hand enables smooth traveling of said label to the deposit edge (5) of the peel-off plate, is within the admit of the present invention. Suitable materials include but are not limited to, a roller conveyer, slidably support blade, air cushion and the like; in particular the support means as used herein consist of a slidable support blade made for example of nano-coated metal or Teflon's such as polytetrafluoretheen (PFTE), Perfluoroalkoxy (PFA), or Fluorinated ethylene propylene (FEP).

For some of the embodiments of the present invention and as exemplified in the drawings hereinafter, in a particular embodiment according to the present invention the surface of the peel-off plate is sloping upward with respect to the running direction of the machine. In particular the support means immediately adjacent and posterior to the peeling edges and corresponding discharge zone, may be configured to lift the label as it is being removed from the backing sheet.

As used herein the “shed zone”, also being referred to as “deposit edge” (5) is nothing more but the edge of the peel-off plate where the label is fully released from the backing sheet and can be grasped by the user or is being dispensed on the item being labelled. Although there are no particular requirements with respect to the inclination, roundness, bluntness and/or width of said deposit edge, recesses such a for example shown in FIG. 2, may assist in marking the shed zone and in the collection of the label.

As used herein “Discharged Zones” generally refers to areas wherein the backing sheet peeled from the roll of labels at the anterior peeling edges is pulled away beneath the peel-off plate. They typically consists of apertures (in particular slits) (2a, 2b) in the surface posterior of the peeling edge with respect to the running direction of the machine; or combinations thereof.

Each of said discharge zones may include discharge guides (7) for receiving and optionally engaging the backing sheet in an orientation extending in bending configuration over the discharge edge.

As will be evident to the skilled artisan from the foregoing description and the examples hereinafter, the peel-off plate of the present invention is characterized in that it enables a stepwise release from the labels of the backing sheet, based on a support surface having at least two peeling edges and corresponding discharge zones, that do not lie in line with one another, with respect to the running direction of the machine, and shed zone (5). But for the fact that said surface must provide support from underneath to the label up to shed zone (5) as it is being removed from the carrier sheet, there are no particular requirements to the constitution of the peel-off plate.

In a particular embodiment however, the peel-off plate is composed of at least two superimposed plates (8a, 8b, 8c), with at least two of said plates comprising a peeling edge (1a, 1b) at its side faced to the backing sheet carrying adhesive labels to be dispensed. Within this embodiment and further to the description of the discharge zones above, the slits in the surface of the peel-off plate(s) may be composed of grooves (7a, 7b) in the superimposed plates adjacent and complementary to the peeling edge on the opposing plate.

Dependent on the relative position of the peeling edges vis-à-vis one another, gaps may occur in the surface of the peel-off plate when composed of a number of superimposed plates. In said instance the supporting means adjacent to at least one, and particular all of said peeling edges, may consist of protrusion (9) complementary to the peeling edge on one of said plates.

In a second aspect the present invention provides a backing sheet carrying adhesive labels for use with the peel-off plate as defined in any one of the foregoing claims and characterized in having at least two preformed zones (10a, 10b) for removing the backing sheet from the labels. In a particular embodiment said preformed zones are formed by die-cutting.

In a final aspect the present invention provides a label dispensing machine comprising a peel-off plate as defined herein.

### BRIEF DESCRIPTION OF THE DRAWINGS

With specific reference now to the figures, it is stressed that the particulars shown are by way of example and for purposes of illustrative discussion of the different embodiments of the present invention only. They are presented in the cause of providing what is believed to be the most useful and readily description of the principles and conceptual aspects of the invention. In this regard no attempt is made to show structural details of the invention in more detail than is necessary for a fundamental understanding of the invention. The description taken with the drawings making apparent to those skilled in the art how the several forms of the invention may be embodied in practice.

FIG. 1: Assembly view of a peel-off plate according to the present invention and composed of three superimposed plates.

FIG. 2: Perspective top view of a peel-off plate according to the present invention and composed of three superimposed plates.

FIG. 3: Assembly view of a peel-off plate according to the present invention and composed of two superimposed plates.

FIG. 4: Perspective top view of a peel-off plate according to the present invention and composed of two superimposed plates.

### DETAILED DESCRIPTION OF THE INVENTION

Referring now by reference numerals to the drawings which illustrate a particular embodiment of the present invention, a supply reel (11) of release coated web carrying having predetermined zones (10a, 10b) for removing the backing sheet and carrying the labels (3) is fed onto the peel-off plate composed of two or three superimposed plates (8a, 8b, 8c) mountable on a standard label printing and/or label dispensing machine.

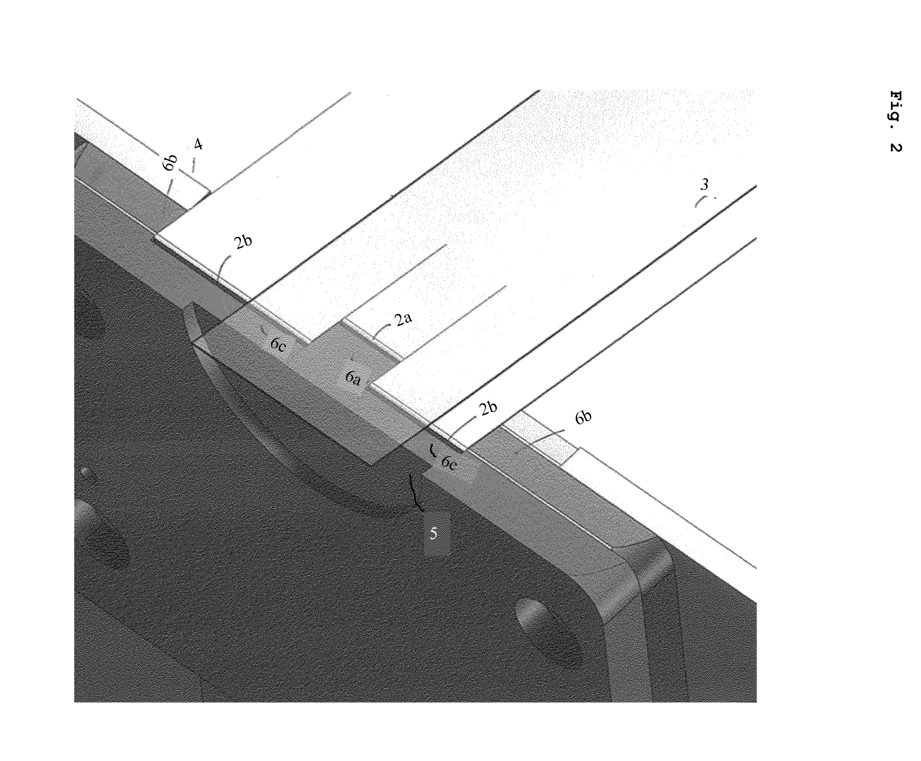

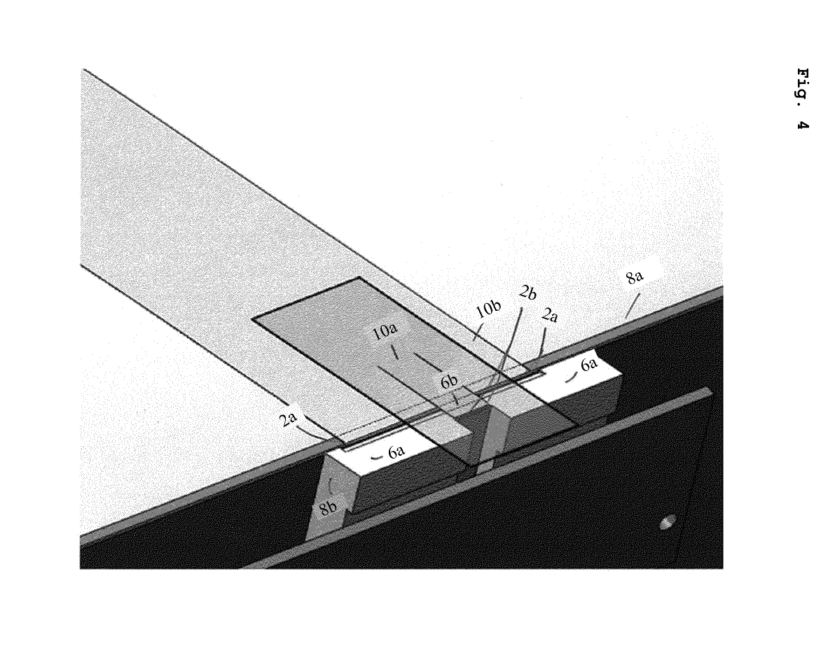

In assembled configuration (FIGS. 2 and 4) the side members of said plates facing the backing sheet, form a surface having at least two peeling edges (1a, 1b) that do not lie in line with one another, corresponding discharge zones (2a, 2b) and label support means providing support from underneath to the label being peeled and positioned (6a, 6b, 6c) posterior of said peeling edges to support the labels as they are peeled from the backing sheet up to the shed zone (5) of the peel-off plate.

In feeding the peel-off plate the preformed zones of the backing sheet are pulled through the discharge zones (2a, 2b) and onto certain rollers positioned relative to the discharge zone for receiving and grippingly engaging the backing sheet in an orientation extending in bended configuration over the peeling edge. A drive motor rotably drives the rollers in a direction for pulling the backing sheet from the peel-off plate surface, over the peeling-edges (1a, 1b) and into the rollers, causing the labels to be peeled from the backing sheet as the backing sheet (10a, 10b) passes over the peeling edges into the respective discharge zones. Neither the physical aspects of the drive motor nor those of its related gearing, including the rollers for pulling the backing sheet, and electrical connections for such operation are specifically illustrated, such mechanical features are conventional and will be readily understood by those skilled in the art.

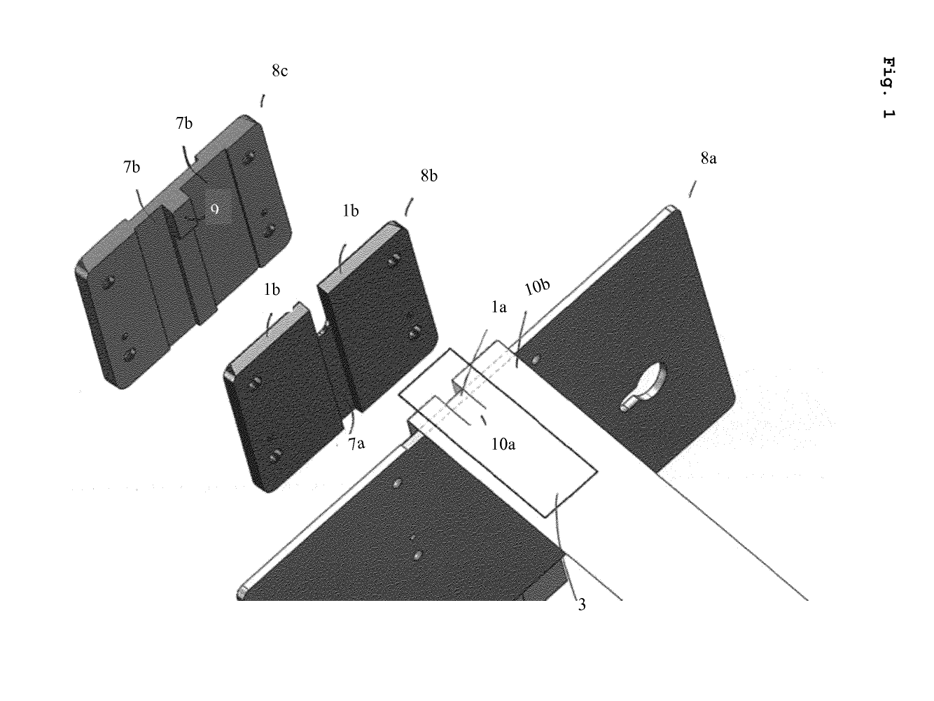

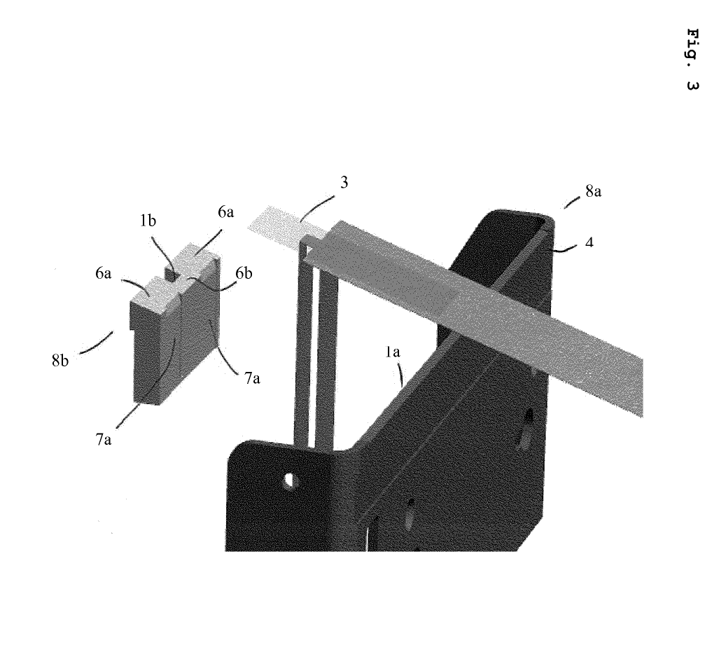

As the label (3) moves forward and reaches the leading edge (4) of the peel-off plate a first portion of the backing sheet is removed and pulled away at a first peeling edge(s) (1a) and corresponding discharge zone (2a). The label together with the still retained backing sheet is further advanced over the peel-off plate till it reaches the further peeling edge(s) (1b) and corresponding discharge zones (2b). During this movement the label is fully supported. By label supporting means 6b and 6a, respectively supporting part of the label still carrying the backing sheet (in FIG. 1 label supporting means 6b, corresponds to the side member of superimposed plate 8b; in FIG. 3 label supporting means 6b, corresponds to the central narrow edge of superimposed plate 8b) and part of the label with the first portion of the backing sheet being removed (in FIG. 1 label supporting means 6a, corresponds to a protrusion (9) up to the side member of superimposed plate 8c, and bridging superimposed plate 8b; in FIG. 3 label supporting means 6a, corresponds to flanking widened edges of superimposed plate 8b). The presence of the label supporting means immediately adjacent and posterior to the first peeling edge (6a) and extending till the deposit edge (5) of the peel off plate will provide a continuous support from underneath to the label during the complete peeling operation.

In this further peeling operation the remaining parts of the backing sheet (10b) are removed and pulled away from the label at the further peeling edges (1b) and corresponding discharge zones (2b).

As evident from the foregoing embodiments, the first label support means (6a), extending till the deposit edge will assure a continuous support from underneath to the label during the complete peeling operation. To prevent eventual loss of the label in the further discharge zones, and as exemplified in the embodiment shown in FIGS. 1 and 2, further support means (6c) may be present at the peel-off plate of the present invention. In said embodiment the first label support means (6a) together with further support means (6c) immediately adjacent and posterior to discharge zones (2b) will prevent loss of the label into said further discharge zones, and assure support from underneath of the peeled off label till being dispensed at the discharge edge (5). Dependent on the flexibility of the labels being dispensed, further elements and/or configurations may be present to contribute to a fault-free operation of the peel-off plate. In the exemplary embodiment of the present drawings the orientation of the further peeling edges is perpendicular to the running direction of the machine. In an alternative embodiment a different orientation or shape of said further peeling edges could provide an even more continuous support or peel result of the label. A further element that may contribute to a fault-free operation in peeling ultra thin or of extremely flexible labels has to do with the trailing edge of the peel off zone means (6c) immediately adjacent and posterior to discharge zones (2b). They may have an appropriate shape, such as for example a ramp, to lift the label as it is being peeled of the backing sheet.

Evidently, in a further aspect the present invention provides a label-dispensing machine comprising a peel-off plate as described. The peel-off plate of the present invention has been configured to fit within the majority of label-dispensing machines or label printers with a peel off option.

The foregoing description of the invention has a number of particular features which should preferably be employed in combination although each is useful separately without departure from the scope of the invention. It will be understood that the invention may be embodied otherwise than as herein specifically illustrated or described, and that certain changes in the form and arrangement of parts and the specific manner of practicing the invention may be made within the underlying idea or principles of the invention and are within the scope of the appended claims.

1-16. (canceled)

17. A peel-off plate for use with a backing sheet carrying adhesive labels to be dispensed in a label-dispensing machine, comprising a surface with at least two peeling edges positioned relatively to corresponding discharge zones; characterized in that said peeling edges do not lie in line with one another, with respect to the running direction of the machine; and in that it comprises label support means posterior to the peeling edges up to shed zone.

18. The peel-off plate according to claim 17, wherein said peeling edges consist of a central peeling edge and, two flanking peeling edges, characterized in that said central peeling edge and flanking peeling edges do not lie in line with one another, with respect to the running direction of the machine.

19. The peel-off plate according to claim 18, wherein the central peeling edge is proximal to a leading edge of the peel-off plate, when compared to the flanking peeling edges.

20. The peel-off plate according to claim 18, wherein the central peeling edge is distal to a leading edge of the peel-off plate, when compared to the flanking peeling edges.

21. The peel-off plate according to claim 17, wherein said label support means are adjacent to a first peeling edge of the at least two peeling edges.

22. The peel-off plate according to claim 18, wherein said label support means are adjacent to the central peeling edge, wherein the central peeling edge is positioned centrally with respect to the labels to be dispensed, and adjacent to the flanking peeling edges, wherein said flanking peeling edges are flanking said central peeling edge.

23. The peel-off plate according to claim 18, wherein said label support means are present adjacent to the flanking peeling edges.

24. The peel-off plate according to claim 17, wherein said label support means are selected from the group consisting of a roller conveyer, slidably support blade, and air cushion.

25. The peel-off plate according to claim 17, wherein the discharge zones consist of apertures in the surface posterior of the peeling edge with respect to the running direction of the machine.

26. The peel-off plate according to claim 17, wherein the surface of the peel-off plate is sloping upward with respect to the running direction of the machine.

27. The peel-off plate according to claim 17, wherein the discharge zones include discharge guides for receiving and optionally engaging the backing sheet in an orientation extending in bending configuration over a discharge edge.

28. The peel-off plate according to claim 17, composed of at least two superimposed plates, at least two of said superimposed plates comprising a peeling edge at its side facing to the backing sheet carrying adhesive labels to be dispensed.

29. The peel-off plate according to claim 28, wherein the discharge zones consist of grooves in the superimposed plates adjacent and complementary to the peeling edge on the opposing plate.

30. The peel-off plate according to claim 28, wherein the label support means adjacent to at least one of said peeling edges, comprise protrusions complementary to the peeling edge on one of said plates.

31. A backing sheet carrying adhesive labels for use with the peel-off plate as defined in claim 17 and characterized in having at least two preformed zones; for removing the backing sheet from the labels.

32. A label dispensing machine comprising the peel-off plate defined in claim 17.
